(19) United States
(12) Patent Application Publication
(10) Pub. No.: US 2007/0054256 A1
(43) Pub. Date: Mar. 8, 2007

(54) Mock circulatory apparatus

(76) Inventors: Jeremy Low, Hornsby (AU); Mark Alan Von Huben, Waverton (AU)

Correspondence Address: LADAS & PARRY LLP, 224 SOUTH MICHIGAN AVENUE, SUITE 1600, CHICAGO, IL, 60604, US

(21) Appl. No.: 11/512,678

(22) Filed: Aug. 30, 2006

(30) Foreign Application Priority Data
Sep. 6, 2005 (AU) 2005 905162

(51) Int. Cl. G09B 23/28

(52) U.S. Cl. 434/268

(57) ABSTRACT

A mock circulatory apparatus for use in simulating the circulatory system of a patient comprising of a fluid circuit, wherein said fluid circuit includes a mock ventricle; at least one fluid reservoir and tubing. The valveless blood pump is connected in parallel fluid communication to said fluid circuit across the mock ventricle.

### FIELD OF THE INVENTION

The present invention relates to a mock circulatory apparatus for use with valveless blood pumps. These valveless blood pumps are generally rotary type pumps.

### BACKGROUND OF THE INVENTION

In the past, there have been many mock circulatory apparati used and disclosed. The prior art includes mock systems that simulate a natural circulatory system of a patient which has been implanted with a pulsatile blood pump. These systems may generally include one or more pulsatile pumps, which function as mock simulations of the patient's heart. Typically, these pulsatile pumps are in series fluid communication with a fluid circuit that simulates the arteries, veins, capillaries and other organs of a patient's body. This fluid circuit may be achieved by the use of fluid reservoir and assorted tubing to form said fluid circuit. All pulsatile pumps include mechanical valves.

Described in U.S. Pat. No. 5,632,623—Kolff et al is a device that includes two pulsatile pumps connected in series in respect to the fluid circuit of a mock circulatory system. This device allows the user to disable one mock ventricle and replace it with a hand squeezed pump, still in series, to facilitate training in cardiac massage and to also demonstrate the operation of a pulsatile pump when connected to a circulatory system. This device may be not suitable of demonstrating left ventricle assist devices or valveless blood pumps.

Another device, as described in U.S. Pat. No. 6,517,354—Levy, simulates pulsatile blood flow through a vessel simulating different vascular conditions. The apparatus includes a single pulsatile pump, a single fluid reservoir and the vessel simulating the vascular condition all of the components are connected in series fluid communication in the fluid circuit. A single fluid reservoir of the configuration shown within this disclosure generally would not significantly demonstrate the pressure in a real patient as the inclusion of only one reservoir does not accurately simulate fluid pressures within a body with multiple organs or pumping devices or chambers.

The prior art generally cannot be used to demonstrate how a valveless blood pump may assist the functions of a mock heart in parallel. A significant proportion of implantable blood pumps are valveless and are implanted to assist the normal function of the left ventricle of a heart rather than totally replace the heart. Therefore these types of implantable blood pumps are typically implanted in parallel fluid communication with the left ventricle.

By connecting pumps in series fluid communication the prior art is incapable of demonstrating how a valveless blood pump is capable of assisting the functions of a real patient's heart. Series configurations of the pumps with the fluid circuit are generally incapable of demonstrating adverse situations experienced the left ventricle when connected to a pump and these adverse situation include backflow or regurgitant flow. Backflow, or regurgitant flow, may occur if the pumping rate of the parallel valveless blood pump is too slow and the heart rate is sufficient to pump blood back toward the valveless blood pump. Backflow causes the patient's heart to recirculate the same blood back through a portion of the arterial system or a portion of the blood pump system.

The present invention aims to at least address or ameliorate one or more of the above problems.

### SUMMARY OF THE INVENTION

In a first aspect the present invention consists of a mock circulatory apparatus for use in simulating the circulatory system of a patient comprising: a fluid circuit, wherein said fluid circuit includes a mock ventricle; at least one fluid reservoir and tubing; and characterised in that the valveless blood pump is connected in parallel fluid communication to said fluid circuit across the mock ventricle.

Preferably said mock ventricle simulates a left ventricle.

Preferably the outlet of the valveless blood pump is connected to the portion of the fluid circuit that simulates the aorta.

Preferably said mock ventricle is squeezable.

Preferably said fluid circuit includes at least an afterload fluid reservoir and a preload fluid reservoir.

Preferably an inlet of the valveless blood pump is connected to the apex of the mock ventricle.

Preferably the fluid circuit includes at least one flow meter.

Preferably a flow meter is positioned in an outflow cannula of the valveless blood pump.

Preferably the pressure within the fluid circuit is adjusted by at least one flow resistor and said flow resistor is attached to a portion of the fluid circuit.

Preferably said mock circulatory apparatus includes at least one pressure sensor to monitor pressure.

Preferably said mock circulatory apparatus includes at least one transparent region.

Preferably the fluid within the fluid circuit includes aqueous glycol.

In a second aspect the present invention consists of a mock circulatory apparatus for use with a valveless blood pump, said apparatus comprising a fluid circuit having at least one mock ventricle, and at least one fluid reservoir in fluid communication with said mock ventricle via tubing, wherein said mock ventricle simulates a left ventricle and said valveless blood pump is connected in parallel fluid communication to said fluid circuit across said mock ventricle.

### BRIEF DESCRIPTION OF THE DRAWINGS

Embodiments of the present invention will now be described with reference to the accompanying drawings wherein:

FIG. 1 is a schematic view of a first preferred embodiment of the present invention;

FIG. 2 is an enlarged view of a portion of the first preferred embodiment; and

FIG. 3 is a side view of a preferred Hoffmann clamp for use with the first preferred embodiment.

### BRIEF DESCRIPTION OF THE PREFERRED EMBODIMENTS

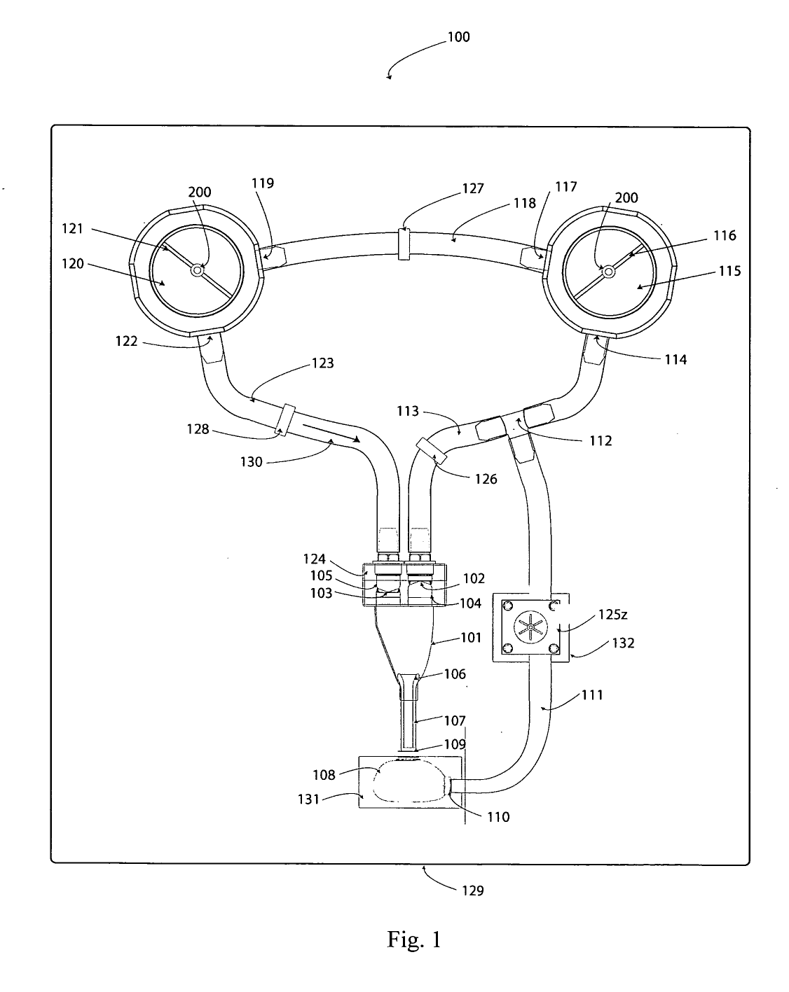

In a first preferred embodiment of the present invention, as depicted in FIG. 1, there is a mock circulatory apparatus 100 for use in demonstrating the operation of a valveless blood pump 108 in parallel fluid communication with a mock ventricle 101. By operating the valveless blood pump 108 in parallel fluid communication with the mock ventricle 101 it is possible to demonstrate how the valveless blood pump 108 assists the function of the mock ventricle 101 and what conditions create backflow through the valveless blood pump 108.

Preferably, the mock ventricle 101 may be a hand operated, squeezable mock ventricle. In this specification, ‘squeezable’ means flexible yet resilient, able to be squeezed by the hand but then restore its former shape. As the mock ventricle 101 is preferably squeezable, the user may simulate cardiac massage or artificially simulate changes in heart rate by manipulation of the mock ventricle 101.

The user may squeeze the mock ventricle 101 by different amounts at different rates while operating the valveless blood pump 108. The valveless blood pump 108 may also be operated at different pumping speeds to see what flow rate and flow direction arises in each case. Additionally, the fluid pressure may be increased by applying a combination of flow resistors shown at 126, 127 and 128 to simulate pressure changes due to certain heart and vascular conditions. Preferably the tubes 113, 118 and 123 and mock ventricle 101 may be made of flexible and transparent material, preferably silicon, to enable the fluid to be viewed.

The preferred valveless blood pump 108 for use with the mock circulatory system 100 is the VentraAssist™ blood pump or left ventricle assist device is described in U.S. Pat. Nos. 6,227,797, 6,250,880, 6,609,883, & 6,638,011—Watterson et al. The descriptions and embodiments of these pumps and systems disclosed within these patents are herein included within the current description of the present invention.

The mock circulatory apparatus 100 includes a housing 129, a fluid circuit 130, and the valveless blood pump 108 in parallel fluid communication with the fluid circuit 130. The fluid circuit 130 simulates a mock circulatory system and includes the mock ventricle 101, an afterload fluid reservoir 115 and a preload fluid reservoir 120. Preferably, the afterload fluid reservoir 115 and preload fluid reservoir 120 are made of a transparent material to enable the fluid to be viewed.

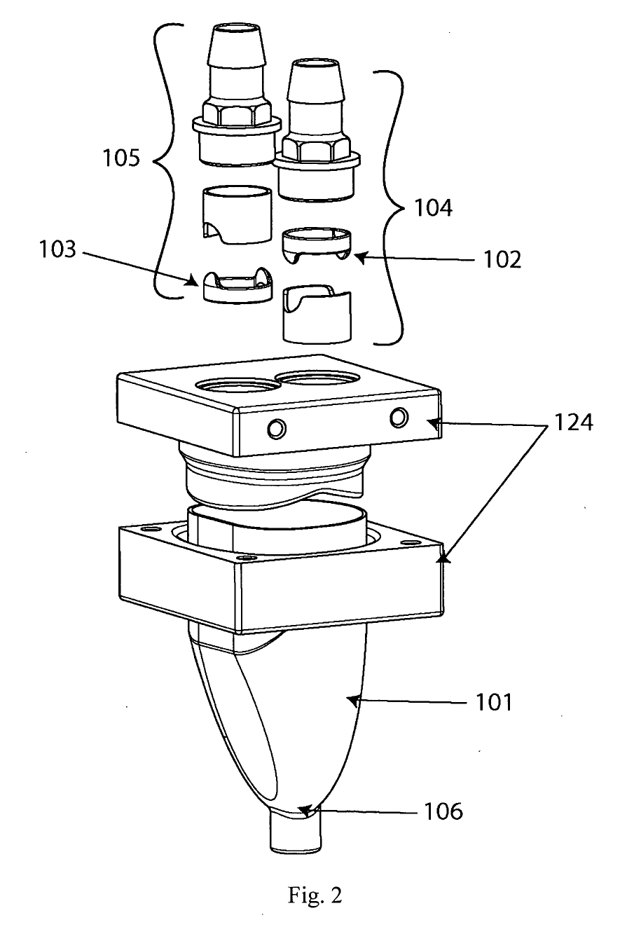

The mock ventricle 101 includes an input valve 103, an output valve 102 and a cored hole 106. The input valve 103 only allows fluid to enter the mock ventricle 101 while the output valve 102 only allows fluid to exit the mock ventricle 101. The preferred valves 102 & 103 are commercially available artificial heart valves suitable for human implant. In the first preferred embodiment, the mock ventricle 101 represents the left ventricle of a real heart, the output valve 102 represents an aortic valve, and the input valve 103 represents a mitral valve. Fluid exits the output valve assembly 104, preferably as depicted in FIG. 2, through the output valve 102 into a first tube 113 representing an aorta and into the second inlet 114 to the afterload fluid reservoir 115. The afterload fluid reservoir 115 includes a first partition 116 to interrupt the flow between the second inlet 114 and second outlet 117 of the afterload fluid reservoir 115 and reduce turbulence. The second outlet 117 of the afterload fluid reservoir 115 is then connected by a second tube 118, representing a peripheral vascular system to the third inlet 119 of the preload fluid reservoir 120. The flow between the third inlet 119 and third outlet 122 of the preload fluid reservoir 120 is similarly interrupted by a second partition 121, as described for the first partition 116. Fluid then flows from the third outlet 122 through a third tube 123 simulating a pulmonary vein into the input valve assembly 105, preferably as depicted in FIG. 2, through the input valve 103 and into the mock ventricle 101. In the first preferred embodiment, the output valve assembly 104 and the input valve assembly 103 are encased by a valve assembly casing 124 to which the top of the mock ventricle 101 is attached. The output valve assembly 104 and input valve assembly 103 are preferably screw fitted to the valve assembly casing 124 in the configuration depicted in FIGS. 1 & 2.

Fluid is also able to exit and enter the mock ventricle 101 through the cored hole 106, preferably positioned at the apex of the mock ventricle 101. The cored hole 106 simulates the hole that would be cored if the blood pump 108 was connected to a real patient. The cored hole 106 is connected to the first inlet 109 of the valveless blood pump 108 by an inflow cannula 107. The first outlet 110 of the valveless blood pump 108 is connected back into the first tube 113 by an outflow cannula 111 at a junction 112. The outflow cannula 111 and first tube 113 are preferably connected to the junction using cord or cable ties.

A flow meter 125 may also be included in the outflow cannula 111 to visually indicate the pumping rate of the valveless blood pump 108 and the direction of flow. Another flow meter, not shown, may be included in the fluid circuit 130. Visualisation of the flow may be improved through the inclusion of coloured material in the fluid, preferably powdered red mica to imitate the appearance of blood. The visualisation of the motion of the fluid may be assisted by colouring the fluid or increasing the viscosity of the fluid by adding a portion of aqueous glycol. The fluid may be coloured with powdered red mica. Both the flow meter 125 and valveless blood pump 108 may be attached to mounts 132 and 131 respectively, which enable them to slide on the housing 129 when the mock ventricle 101 contracts and relaxes.

The afterload fluid reservoir 115 and preload fluid reservoir 120 may be sealed, and pressure sensors 200 may be included to measure gas pressure in the afterload fluid reservoir 115 and preload fluid reservoir 120. Preferably, the pressure sensors 200 would be mounted on the tops of the afterload fluid reservoir 115 and preload fluid reservoir 120. The preload fluid reservoir 120 may be calibrated such that the gas pressure above the fluid is 10 mm Hg, reflecting the preload pressure measured in a patient. Pressure sensors may be included to measure fluid pressure at a number of positions, notably in the mock ventricle 101, in the inflow cannula 107, outflow cannula 111, and in the liquid in the afterload fluid reservoir 115 and preload fluid reservoir 120. The afterload fluid reservoir 115 and preload fluid reservoir 120 may include gradations or markings along the side of the reservoirs 115 and 116. These graduations may indicate the level to which the system should be filled and may also enable the user to monitor how the fluid levels vary with changing pumping speeds of the mock ventricle 101 and valveless blood pump 108.

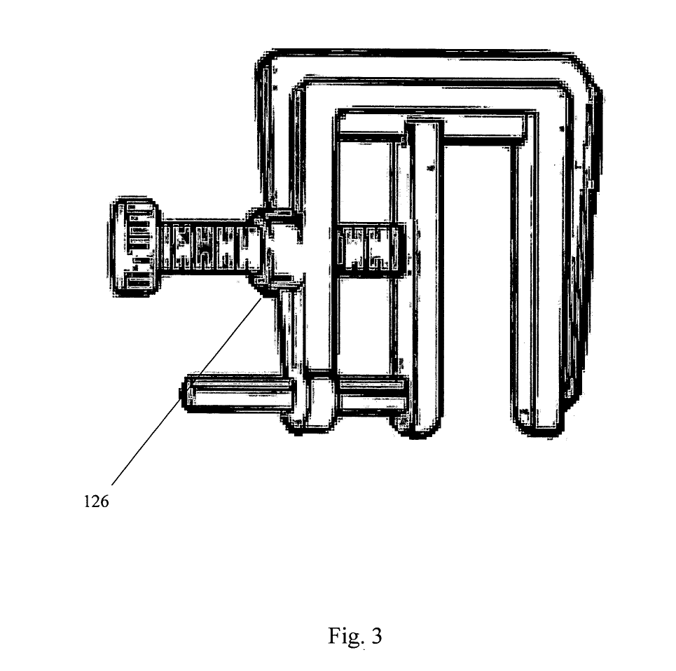

The mock circulatory apparatus 100 is capable of being adapted to simulate different heart and vascular conditions. The pressure in the tubes 113, 118 and 123 included in the fluid circuit 130 may be increased by the application of flow resistors 126, 127 & 128 at the positions respectively depicted in FIG. 1. Preferably the flow resistors 126, 127 & 128 may be Hoffmann clamps as depicted in FIG. 3. Those persons skilled in the art may recognise that hypertension may be simulated by resisting the fluid flow at any or all of positions that the flow resistors 126, 127 or 128 are depicted, although in a patient flow is most commonly restricted in the peripheral vascular system, represented by the second tube 118. Flow resistance may directly simulate arteriosclerosis or atherosclerosis. The application of a first flow resistor at position 126 may simulate aortic stenosis, although placing the flow resistor on the other side of the junction will also increase afterload and preload pressure and potentially simulate an alternative condition. Aortic stenosis may also be represented by including a faulty valve in place of the output valve 102 representing the aortic valve. Failure of the right side of the heart may be simulated by applying a second flow resistor at position 127 such that fluid is retained in the afterload fluid reservoir 120. Failure of the left side of the heart may be simulated by applying a third flow resistor at 128 such that fluid is retained in the preload fluid reservoir 115. This is a non-exclusive list of examples of heart and vascular conditions that may be simulated.

Other conditions that may be simulated by the mock circulatory apparatus 100 may be implemented by altering the pumping pattern of the mock ventricle 101. Faster pumping of the mock ventricle 101 may simulate an influx of hormones such as adrenaline or nor-adrenaline, or disorders in myocardial function caused by thyrotoxicosis or anaemia for example. Slowed heart rate in the mock ventricle 101 may simulate increased acetylcholine levels or reduced contractibility due to ischaemic heart disease, myocardial infarction, or hypertrophy. To simulate these heart conditions with greater scientific accuracy it is possible to replace the hand of the user with a mechanical hand capable of pumping the mock ventricle in a way which represents the heart condition of interest.

The preferred embodiment of the mock circulatory apparatus 100 includes two reservoirs, although it is foreseeable that these could be combined. Persons skilled in the art may also be aware that combining the reservoirs 115 & 116 may make the fluid flow in the fluid circuit 103 less representative of the flow within a real patient's circulatory system.

The above descriptions detail only some of the embodiments of the present invention. Modifications may be obvious to those skilled in the art and may be made without departing from the scope and spirit of the present invention.

The term “comprising” (and its grammatical variations) as used herein is used in the inclusive sense of “having” or “including” and not in the exclusive sense of “consisting only of”.

1. A mock circulatory apparatus for use in simulating the circulatory system of a patient comprising: a fluid circuit, wherein said fluid circuit includes a mock ventricle; at least one fluid reservoir and tubing; and characterised in that the valveless blood pump is connected in parallel fluid communication to said fluid circuit across the mock ventricle.

2. A mock circulatory apparatus as claimed in claim 1, wherein said mock ventricle simulates a left ventricle.

3. A mock circulatory apparatus as claimed in claim 2, wherein the outlet of the valveless blood pump is connected to the portion of the fluid circuit that simulates the aorta.

4. A mock circulatory apparatus as claimed in claim 1, wherein said mock ventricle is squeezable.

5. A mock circulatory apparatus as claimed in claim 1, wherein said fluid circuit includes at least an afterload fluid reservoir and a preload fluid reservoir.

6. A mock circulatory apparatus as claimed in claim 1, wherein an inlet of the valveless blood pump is connected to the apex of the mock ventricle.

7. A mock circulatory apparatus as claimed in claim 1, wherein the fluid circuit includes at least one flow meter.

8. A mock circulatory apparatus as claimed in claim 7, wherein a flow meter is positioned in an outflow cannula of the valveless blood pump.

9. A mock circulatory apparatus as claimed in claim 1, wherein the pressure within the fluid circuit is adjusted by at least one flow resistor and said flow resistor is attached to a portion of the fluid circuit.

10. A mock circulatory apparatus as claimed in claim 1, that includes at least one pressure sensor to monitor pressure.

11. A mock circulatory apparatus as claimed in claim 1, wherein said mock circulatory apparatus includes at least one transparent region.

12. A mock circulatory apparatus as claimed in claim 1, wherein the fluid within the fluid circuit includes aqueous glycol.

13. A mock circulatory apparatus for use with a valveless blood pump, said apparatus comprising a fluid circuit having at least one mock ventricle, and at least one fluid reservoir in fluid communication with said mock ventricle via tubing, wherein said mock ventricle simulates a left ventricle and said valveless blood pump is connected in parallel fluid communication to said fluid circuit across said mock ventricle.
